(19) United States
(12) Patent Application Publication
(10) Pub. No.: US 2013/0236065 A1
(43) Pub. Date: Sep. 12, 2013

(54) IMAGE SEMANTIC CLOTHING ATTRIBUTE

(71) Applicants: Xianwang Wang, (US); Tong Zhang, San Jose, CA (US)

(72) Inventors: Xianwang Wang, (US); Tong Zhang, San Jose, CA (US)

(21) Appl. No.: 13/417,412

(22) Filed: Mar. 12, 2012

(51) Int. Cl. G06K 9/68

(52) U.S. Cl. 382/111

(57) ABSTRACT

Embodiments disclosed herein relate to a semantic clothing attribute in an image. A probability of a semantic clothing attribute in an image may be determined. The probability of the semantic clothing attribute may be determined based on a comparison of the image to an image feature associated with the semantic clothing attribute.

### BACKGROUND

Automated image analysis methods may be used to identify images of similar content. Image analysis may be used to help retrieve photographs of a particular person or to organize photographs based on people in the photographs. For example, facial recognition methods may be used to identify images including the same person.

### BRIEF DESCRIPTION OF THE DRAWINGS

The drawings describe example embodiments. The following detailed description references the drawings, wherein:

FIG. 1 is a block diagram illustrating one example of an apparatus.

FIG. 2 is a block diagram illustrating one example of an apparatus.

FIG. 3 is a flow chart illustrating one example of a method to determine the similarity of images based on semantic clothing attributes.

FIG. 4 is a diagram illustrating one example of ranking the similarity of images based on semantic clothing attributes.

### DETAILED DESCRIPTION

Classifying images based on semantic clothing attributes, such as clothing parts, categories, or descriptors, may improve the ability to retrieve images including the same clothes as in a query image. A supervised learning method may be used to create a semantic clothing attribute classifier for associating image features with a semantic clothing attribute. The semantic clothing attribute classifier may be applied to an image to determine the probability of the presence of the semantic clothing attribute in the image. For example, the presence of a particular set of low level image features may indicate that the image includes the semantic clothing attribute of a tie.

In one implementation, the probability of the presence of semantic clothing attributes in images may be used to retrieve images similar to a query image. A similarity level between two images may be determined based on the similarity of the semantic clothing attributes in the images. For example, two images including a suit may be considered more similar than where one image includes a suit and the other does not. A similarity level may be assigned to the images based on a comparison of the semantic clothing attributes in the images.

A semantic clothing attribute may be used for information retrieval, such as to retrieve images of the same person. For example, semantic clothing attributes may be used by themselves or in addition to a facial recognition method. Semantic clothing attributes may be used to retrieve images of people in a particular outfit or style of outfit, or may be used to retrieve pictures of the same person in different outfits. The same semantic clothing attributes may be identified in images despite other differences in the images and the subjects of the images, such as differences in scale, pose, illumination, or background.

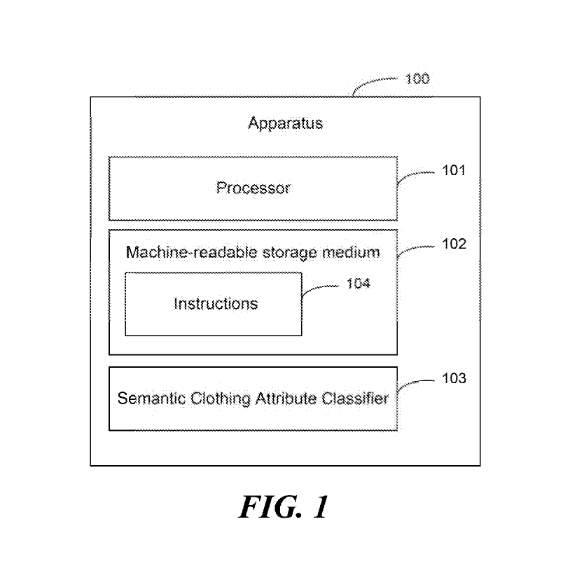

FIG. 1 is a block diagram illustrating one example of an apparatus 100. The apparatus 100 may be used to determine the presence of a semantic clothing attribute in an image. The determination of the probability of a semantic clothing attribute may be based on a semantic clothing attribute classifier created using a supervised learning method and a training data set of images with the semantic clothing attribute and images without the semantic clothing attribute.

The apparatus 100 may include a processor 101, a machine-readable storage medium 102, and a semantic clothing attribute classifier 103. The processor 101 may be any suitable processor, such as a central processing unit (CPU), a semiconductor-based microprocessor, or any other device suitable for retrieval and execution of instructions. In one embodiment, the apparatus 100 includes logic instead of or in addition to the processor 101. As an alternative or in addition to fetching, decoding, and executing instructions, the processor 101 may include one or more integrated circuits (ICs) or other electronic circuits that comprise a plurality of electronic components for performing the functionality described below. In one implementation, the apparatus 100 includes multiple processors. For example, one processor may perform some functionality and another processor may perform other functionality.

The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include instructions 104 executable by the processor 101.

The machine-readable storage medium 102 may include instructions 104 to create the semantic clothing attribute classifier 103. The semantic clothing attribute classifier 103 may classify a semantic clothing attribute. The semantic clothing attribute may be, for example, a clothing category, such as shirt, a clothing part, such as button, or clothing descriptor, such as horizontal stripe. A semantic clothing attribute classifier 103 may be created for each semantic clothing attribute or the same classifier may be used for multiple semantic clothing attributes.

A list of semantic clothing attributes may be manually determined, and the semantic clothing attribute classifier 103 may be created using a training data set where the determined semantic clothing attributes are identified in the training images in the training data set. The semantic clothing attribute classifier 103 may use the training images to associate image features with a semantic clothing attribute. The training data set may include images with the same semantic clothing attribute with different image conditions, such as different lighting and backgrounds, to allow for the created semantic clothing attribute classifier 103 to identify image features associated with the semantic clothing attribute in different image conditions.

The processor 101 may create the semantic clothing attribute classifier 103 for associating an image feature with a semantic clothing attribute based on a supervised learning method performed on the training data set. For example, a non-linear probabilistic classification method may be used. In one implementation a least-squares posterior classifiers (LPSC) method is used to create the semantic clothing attribute classifier 103.

The semantic clothing attribute may describe a clothing feature in human interpretable manners, and the supervised learning method may map image features to the semantic clothing attribute. The semantic clothing attribute classifier 103 may identify the semantic clothing attribute based on any suitable image features. As an example, a supervised learning method may be used to identify three image features associated with a semantic clothing attribute. The image features may include different types of image features, for example, a local shape of clothing in an image, a local appearance of clothing in an image, or a global appearance of the clothing in an image. For example, the vertical or horizontal stripes on clothing may be determined using a local shape feature like a histogram of edge orientation. The R, G, B values of pixels may be analyzed to determine the image features present in the images. In some cases, different types of image features may be used for different types of semantic clothing attributes. For example, a first type of image feature may be analyzed for a clothing category and a second type of image feature may be analyzed for a clothing descriptor. A set of image features may be associated with a semantic clothing attribute based on analysis of the training data set, and the set of image features may be concatenated to form the semantic clothing attribute classifier 103.

The processor may store information about the created semantic clothing attribute classifier 103 for later use to apply it to images. For example, the semantic clothing attribute classifier 103 information may be stored in a database or in a data structure. In some implementations, the semantic clothing attribute classifier 103 may be transmitted to another electronic device. The semantic clothing attribute classifier 103 may be stored for use in determining the probability of the semantic clothing attributes being present in an image. For example, the semantic clothing attribute classifier 103 may be used to find images with clothing similar to clothing in another image or to find images with a set of semantic clothing attributes requested by user input. The semantic clothing attribute classifier 103 may be created in conjunction with a similarity search or may be created and stored for later use in a similarity search.

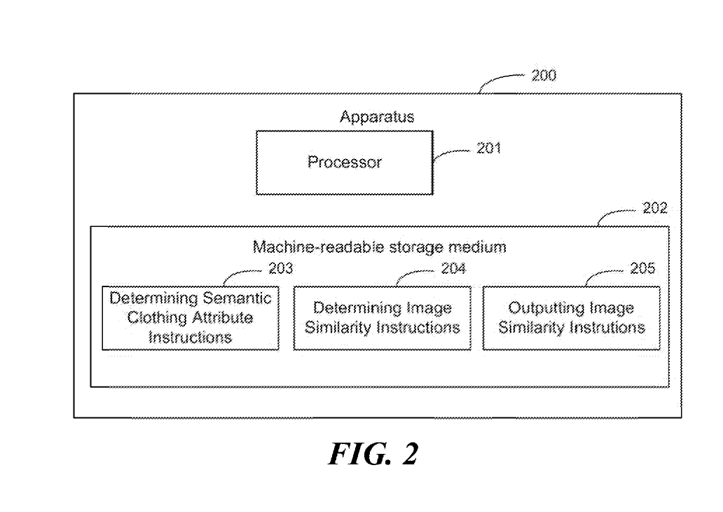

FIG. 2 is a block diagram illustrating one example of an apparatus. The apparatus 200 may determine the probability of semantic clothing attributes being present in a query image and determine images likely to be similar to the query image based on the probability of the presence of the semantic clothing attributes in the other images. Determining similarity based on semantic clothing attributes may be used, for example, for identifying images with a particular person or identifying images with a particular outfit or type of outfit.

The apparatus 200 may include a processor 201 and a machine-readable storage medium 202. The processor 201 may be any suitable processor, such as a central processing unit (CPU), a semiconductor-based microprocessor, or any other device suitable for retrieval and execution of instructions. In one embodiment, the apparatus 200 includes logic instead of or in addition to the processor 201. As an alternative or in addition to fetching, decoding, and executing instructions, the processor 201 may include one or more integrated circuits (ICs) or other electronic circuits that comprise a plurality of electronic components for performing the functionality described below. In one implementation, the apparatus 200 includes multiple processors. For example, one processor may perform some functionality and another processor may perform other functionality.

The machine-readable storage medium 202 may be any suitable machine-readable storage medium, such as an electronic, magnetic, optical, or other physical storage device that stores executable instructions or other data (e.g., a hard disk drive, random access memory, flash memory, etc.). The machine-readable storage medium 202 may be, for example, a computer readable non-transitory medium. The machine-readable storage medium 202 may include instructions 202 executable by the processor 201.

The machine-readable storage medium 202 may include determining semantic clothing attribute instructions 203, determining image similarity instructions 204, and outputting image similarity instructions 205. The determining semantic clothing attribute instructions 203 may include instructions to determine the probability of a semantic clothing attribute being present in an image. For example, the determination may be made using a semantic clothing attribute classifier, such as the semantic clothing attribute classifier 103 in FIG. 1. The determining image similarity instructions 204 may include instructions to determine a similarity between images based on the probability of particular semantic clothing attributes being present in the images. For example, a high probability of the same semantic clothing attribute being present in both images may increase the likelihood that clothing in the images is similar. The outputting image similarity instructions 205 may include instructions to output information about image similarity. For example, a query image may be provided and a similarity level with the query image may be determined for other images based on the probability of semantic clothing attributes in the images. Information about images with a similarity level above a threshold may be output to a user.

In one implementation, a first electronic device determines the presence of the semantic clothing attribute in images and a second electronic device determines a similarity between the images based on the presence of the semantic clothing attributes. For example, the first and second electronic devices may communicate via a network.

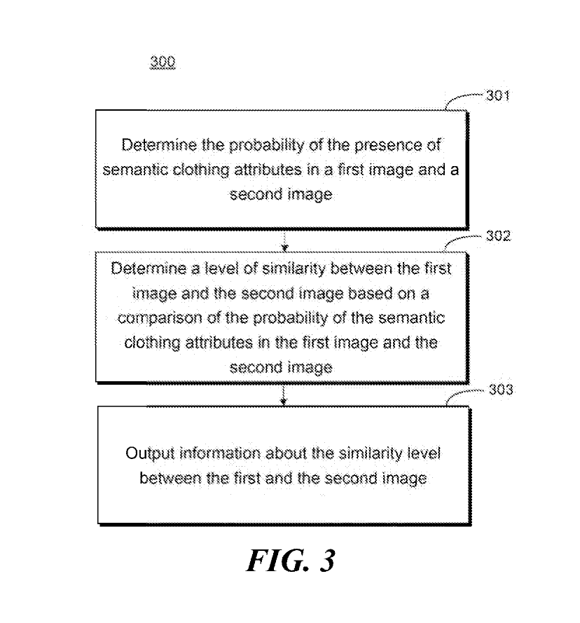

FIG. 3 is a flow chart illustrating one example of a method to determine the similarity of images based on semantic clothing attributes. The probability of the presence of semantic clothing attributes may be determined for the images, such as based on a semantic clothing attribute classifier, and the similarity between images may be determined based on semantic clothing attributes likely to be in common between the images. For example, the similarity between two images may be based on semantic clothing attributes that have a low probability of being included in both images and semantic clothing attributes that have a high probability of being included in both images. In one implementation, the probability of the semantic clothing attributes may be used to retrieve images likely to include a particular set of semantic clothing attributes. For example, a query image may be provided, and the method may be used to determine images with clothing similar to the clothing in the query image. The method may be implemented, for example, by the apparatus 200.

Beginning at 301, a processor determines the probability of the presence of semantic clothing attributes in a first image and a second image based on features in the images. The probability of a semantic clothing attribute being present in an image may be based, for example, on a semantic clothing attribute classifier associated with the semantic clothing attribute, such as the semantic clothing attribute classifier 103 in FIG. 1. The processor may be the same processor that created the semantic clothing attribute classifier or a different processor. Image features in the images may be fed into the semantic clothing attribute classifier associated with the particular semantic clothing attribute to get a result indicating the probability of the semantic clothing attribute being present within the image.

A first semantic clothing attribute classifier for a first semantic clothing attribute may be applied to an image to determine the probability of the first semantic clothing attribute being in the image and a second semantic clothing attribute classifier for a second semantic clothing attribute may be applied to the image to determine the probability of the second semantic clothing attribute being in the image. For example, there may be an 80% probability that clothing associated with a person in an image includes a tie, 30% probability that the clothing includes a collar, and a 60% probability that the clothing includes a floral pattern.

In some implementations, determining a subsequent semantic clothing attribute may be dependent on the presence or absence of a previous semantic clothing attribute. For example, if the semantic clothing attribute collar is not found, the processor may not look for a tie semantic clothing attribute. As another example, a processor may search for images with a set of semantic clothing attributes found in another image, and if a first clothing attribute is not found, the processor may not proceed to look for the remaining semantic clothing attributes in the set.

In some implementations, additional processing may be performed after determining the probability of the semantic clothing attribute being present in an image. For example, a binary value may be associated with the semantic clothing attribute such that a probability over a particular threshold is associated with the semantic clothing attribute being present and a probability below a particular threshold is not associated with the semantic clothing attribute being present.

In one implementation, the processor performs preprocessing on the image prior to determining the presence of the semantic clothing attribute. The processor may determine the position of clothing within the image to remove other interferences, such as the background of the image. For example, the processor may determine the location of a face in an image and determine a location for clothing based on the position of the face. In some cases, the processor may further remove skin from the clothing region and determine the presence of the semantic clothing attribute from the remaining clothing region. In some implementations, the clothing region is further processed. For example, the processor may determine a dominant patch or group of patches in the clothing region and search for the semantic clothing attribute within the dominate patch, such as a dominant color patch in the clothing region.

In one implementation, an image may include multiple sets of clothing. For example, an image may include two people, and the processor may determine a clothing region associated with each of the people. The processor may search for the semantic clothing attribute in the clothing region associated with the first person and search for the semantic clothing attribute in the clothing region associated with the second person. In some cases, a query image may have a particular person selected for retrieving images with similar clothing.

The processor may store information about the presence or absence of the semantic clothing attribute. For example, the processor may send information about the clothing attributes associated with an image to a database in the same apparatus with the processor or a database accessible via a network. In one implementation, a vector is associated with a clothing region and each vector entry is associated with a probability of the presence of a different semantic clothing attribute in the clothing region. For example, each vector entry may be the output of the application of a different semantic clothing attribute classifier.

Continuing to 302, the processor determines a level of similarity between the first image and the second image based on a comparison of the probability of the semantic clothing attributes in the first image and the second image. Using semantic clothing attributes may allow for the same clothing to be found to be similar despite different appearances due to wrinkles, poses, and other variations between the images. An image may be found to be similar to another even if the probabilities of the semantic clothing attributes are different and even if some of the probabilities are different enough to indicate that a semantic clothing attribute is present in one image but not in another. For example, a pose in the images may be different such that different semantic clothing attributes of the same outfit are visible in the image.

The level of similarity may be determined in any suitable manner using the semantic clothing attributes. In some implementations, the processor may determine the number of semantic clothing attributes with a probability over a threshold of being included in both images. In some implementations, semantic clothing attributes not present may be taken into account. For example, two images where both images have a low probability of including a particular semantic clothing attribute may be considered more similar than two images where one image has a low probability of including the particular semantic clothing attribute and the other image has a high probability of including the particular semantic clothing attribute.

In one implementation, a Jeffrey Divergence method is used to compare the probabilities of the semantic clothing attributes in the first image to the probabilities of the semantic clothing attributes in the second image. In one implementation, a vector of the semantic clothing attributes is associated with each person in an image and the vectors are compared to a vector associated with a query image. For example, a similarity between the vectors may be computed. The determined similarity level may be a probability of the two images including the same clothing or the similarity maybe a ranking of images based on their degree of similarity to a query image.

Each of the semantic clothing attributes determined for the images may be compared or a subset of semantic clothing attributes may be compared. For example, a user may input which semantic clothing attributes should be compared of the possible semantic clothing attributes, or the system may determine a subset to compare, such as a set of the most commonly present semantic clothing attributes. The semantic clothing attributes may be compared in a particular order. For example, if a first semantic clothing attribute has a high probability in a first image and a low probability in a second image, the other semantic clothing attributes may not be compared. As another example, if there is a low probability of a suit semantic clothing attribute in two images, the probability of a tie semantic clothing attribute may not be compared in the two images.

In one implementation, factors in addition to the semantic clothing attributes are considered when determining similarity. For example, color information may be considered, such as considering the color of a clothing attribute. Text associated with images may be considered, such as a title of the image. Facial recognition methods may be used in addition to the clothing information. For example, the similarity level may be based on both the facial recognition method and the semantic clothing attribute method. In one implementation, a subset of images is selected using a first method and a similarity with the subset of images is determined using a second method, such as where a subset is creating using facial recognition and the similarity within the subset is determined using semantic clothing attributes. The similarity level based on the semantic clothing attributes may be used to rank images according to similarity or to re-rank images after another method provides an initial similarity ranking.

Moving to 303, the processor outputs information about the similarity between the first and second image. Outputting the similarity may involve, for example, storing, transmitting, or displaying the similarity information. In some implementations, the similarity information may be displayed to a user who may then perform more manual filtering on the set or may provide feedback on the set. Information may be provided ranking images according to their similarity level to a query image. In one implementation, information about images with a similarity level above a threshold with a query image or a number of the most similar images to the query image may be output. The information about the similarity may be used to further refine the similarity ranking. For, example, color information or other information may be factored in to improve the similarity ranking provided by the semantic clothing attribute analysis.

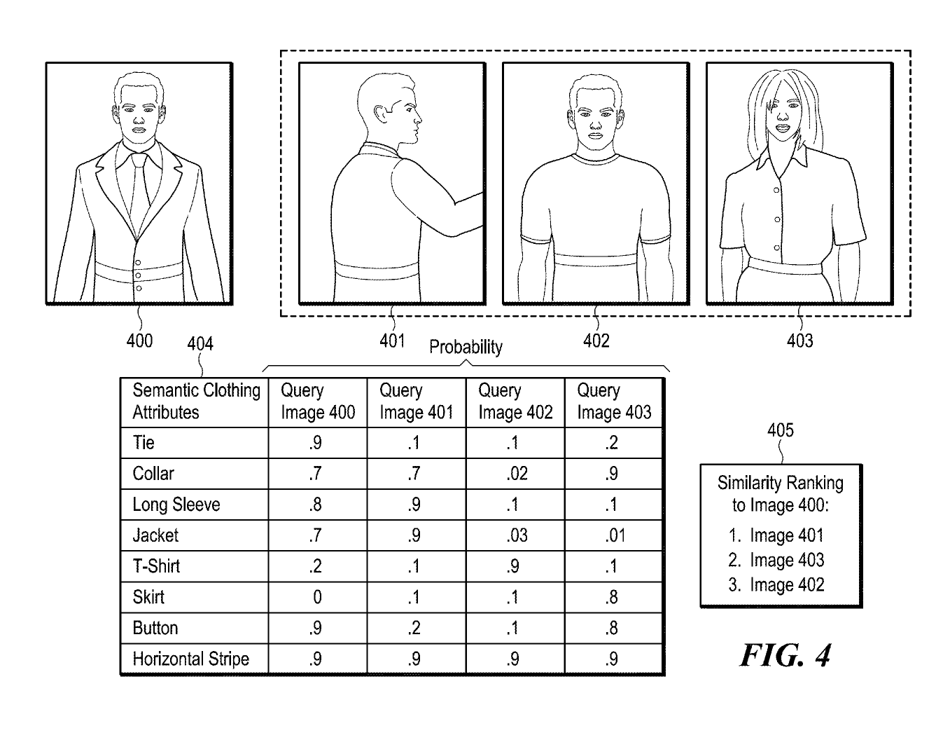

FIG. 4 is a diagram illustrating one example of ranking the similarity of images based on semantic clothing attributes. FIG. 4 shows query image 400 and a set of images including images 401, 402, and 403. Image 401 is an image of the same person as in image 400 but taken from a different perspective such that the same semantic clothing attributes are not each visible in both of the images. Image 402 is an image of the same person with different clothing, and image 403 is an image of a different person in different clothing.

Table 404 shows a list of semantic clothing attributes and the probability of their presence in each of the images 400, 401, 402, and 403. The information in the table 404 may be stored in any suitable format, such as in a data structure or database. The query image 400 has a probability greater than fifty percent of including the tie, collar, long sleeve, jacket, button, and horizontal stripe semantic clothing attributes. Images 400 and 401 both have a probability greater than fifty percent of including a collar, long sleeve, jacket, and horizontal stripe, but image 400 also has a probability greater than fifty percent of including a tie and button. Image 400 and 402 share a greater than fifty percent probability of horizontal stripe, but the image 403 does not include a greater than fifty percent probability of the semantic clothing attributes likely to be found in image 400. Image 400 and 403 share a greater than fifty percent probability of collar, button, and horizontal stripe, but image 403 also includes a greater than fifty percent probability of including a skirt.

Output 405 shows outputting information about a similarity ranking. Image 401 is found to be most similar to'query image 400 because it likely includes the most semantic clothing attributes in common and the least semantic clothing attributes not in common with query image 400. Image 403 is next most similar, and image 402 is the least similar to the image 401.

1. A machine-readable non-transitory storage medium comprising instructions executable by a processor to:
determine the probability of the presence of semantic clothing attributes in a first image and a second image;
determine a level of similarity between the first image and the second image based on a comparison of the probability of the semantic clothing attributes in the first image and the second image; and
output information about the similarity level between the first and second image.

2. The machine-readable non-transitory storage medium of claim 1, wherein the semantic clothing attributes comprise at least one of: a clothing category, a clothing part, or a clothing descriptor.

3. The machine-readable non-transitory storage medium of claim 1, wherein instructions to determine the probability of a semantic clothing attribute present in the images comprises instructions to:
create a semantic clothing attribute classifier for the clothing attribute based on a supervised learning method; and
determine the presence of the clothing attribute in the first and second images based on the semantic clothing attribute classifier.

4. The machine-readable non-transitory storage medium of claim 1, wherein determining a level of similarity between the first image and the second image comprises determining the similarity based on a comparison of a subset of the semantic clothing attributes.

5. The machine-readable non-transitory storage medium of claim 1, wherein determining a level of similarity between the first image and the second image comprises determining a similarity based on comparing the semantic clothing attributes in a particular order.

6. A computing system, comprising:
a storage to store information about image features associated with semantic clothing attributes;
a processor to:
determine a probability of a first semantic clothing attribute in a first image and a second image based on a comparison of the first image and the second image to the stored association information;
determine a probability of a second semantic clothing attribute in the first image and the second image based on a comparison of the first image and the second image to the stored association information;
determine a similarity level between the first image and the second image by comparing the probability of the semantic clothing attributes determined in the first image to the probability of the semantic clothing attributes determined in the second image; and
output information about the similarity between the first image and the second image.

7. The computing system of claim 6, wherein the processor is further to:
performing a supervised learning method on a training data set to determine the image features to associate with the semantic clothing attributes; and
store the information in the storage.

8. The computing system of claim 6, wherein determining a similarity level is further based on a comparison between the color of clothing in the first image and the second image.

9. The computing system of claim 6, wherein the processor is further to:
create a first vector indicating the probability of the first semantic clothing attribute and the probability of the second clothing feature in the first image;
create a second vector indicating the probability of the first semantic clothing attribute and the probability of the second semantic clothing attribute in the second image.

10. The computing system of claim 9, wherein determining the similarity level comprises determining the similarity level based on a comparison of the first vector and the second vector.

11. A method, comprising:
create a semantic clothing attribute classifier for associating an image feature with a semantic clothing attribute based on a supervised learning method performed on a training data set; and
determine a probability of the semantic clothing attribute in an image by comparing the image to the semantic clothing attribute classifier.

12. The method of claim 11, wherein the image features comprise at least one of: a local shape of clothing, a local appearance of clothing, or a global appearance of clothing.

13. The method of claim 11, further comprising determining a level of similarity between the image and a second image based on the probability of the semantic clothing attribute in the image and the second image.

14. The method of claim 11, further comprising storing information in a data structure associated with the image indicating the probability of the semantic clothing attribute in the image.

15. The method of claim 11, wherein the semantic clothing attribute comprises at least one of: a clothing category, a clothing part, or a clothing descriptor.
